(19) United States
(12) Patent Application Publication
(10) Pub. No.: US 2015/0033161 A1
(43) Pub. Date: Jan. 29, 2015

(54) DETECTING A FIRST AND A SECOND TOUCH TO ASSOCIATE A DATA FILE WITH A GRAPHICAL DATA OBJECT

(71) Applicants: Richard James Lawson, Santa Clara, CA (US); Marguerite Letulle, San Mateo, CA (US); Barbara Palmer Pickering, Boulder creek, CA (US); Jared Ficklin, Austin, TX (US)

(72) Inventors: Richard James Lawson, Santa Clara, CA (US); Marguerite Letulle, San Mateo, CA (US); Barbara Palmer Pickering, Boulder creek, CA (US); Jared Ficklin, Austin, TX (US)

(21) Appl. No.: 14/379,843

(22) PCT Filed: Mar. 30, 2012
(86) PCT No.: PCT/US2012/031605

§ 371 Date: Aug. 20, 2014

(51) Int. Cl. G06F 3/0486; G06F 3/0488; G06F 3/0484; G06F 3/041

(52) U.S. Cl. CPC G06F 3/0486; G06F 3/0416; G06F 3/0488; G06F 3/04842; G06F 2203/04104
USPC 715/765

(57) ABSTRACT

Examples disclose a multi-touch display device comprising a display surface to detect a first touch in contact with a graphical data object on the display surface. Additionally, examples disclose the display surface to detect a second touch while the first touch is in contact with the display surface, the second touch selects a data file. Further, the examples provide the multi-touch display device also comprising a processor to associate the data file with the graphical data object.

### BACKGROUND

In today's technology, users rely on multi-touch display devices to perform and render various responses. These types of responses performed by the multi-touch display devices are based on the user's gesture with the device. In performing various multi-touch gestures and rendering the various responses, the user may have a satisfying interactive experience with the multi-touch display device.

### BRIEF DESCRIPTION OF THE DRAWINGS

In the accompanying drawings, like numerals refer to like components or blocks. The following detailed description references the drawings, wherein:

FIG. 1 is a block diagram of an example multi-touch display device including a display surface with a first touch and a second touch, the multi-touch display device also including and a processor to associate a data file with a graphical data object;

FIG. 2 is a block diagram of an example multi-touch display device with a display surface for a first touch to select a graphical data object and a second touch to select a data file, the example multi-touch device includes a processor to associate the data file with the graphical data object;

FIG. 3A is a block diagram of an example display surface of a multi-touch display device with a first touch in contact with a void space and a second touch to select a data file to build a data collection;

FIG. 3B is a block diagram of an example display surface of a multi-touch display device with a first touch in contact with an application and a second touch navigating through a data file to associate the data file with the application;

FIG. 4 is a block diagram of a computing device to detect a first touch and a second touch to transmit coordinates of these touches to associate the data file with the graphical data object, the computing device is further to identify a type of the graphical data object, develop a data collection, and to execute an application; and

FIG. 5 is a flowchart of an example method performed on a computing device to detect a first touch in continuous contact with the display surface, identify a type of graphical data object from the first touch, detect a second touch to associate a data file with the graphical data object, and locate a respective position of the first and the second touch.

### DETAILED DESCRIPTION

Interacting with a multi-touch display device using multi-touch gestures such as drag and drop may be used to perform various tasks like copying a file from one location to another location. This drag and drop gesture requires the user to touch the data file to be copied, hold their finger down on the file and move their finger to the desired drop location. At this drop location, the user releases their finger dropping a copy of the file. This gesture may be ergonomically challenging. For example, the user's movement by holding their arm during this type of gesture requires physical effort that may be tiring. Additionally, some users may not be physically attuned to performing this type of gesture.

In another solution, the multi-touch gesture is used select and delete the file. This operation uses the same finger to tap the file twice to select for launching and/or deletion. For example, the user may use their finger and hold down on an application for a period of time and then tap the application again to delete it. However, this solution requires one finger to perform the gesture and using these two taps may be difficult for the user to tap within a certain tolerance on screen to the file. Further, this limits the type of operations performed on the device with this type of gesture.

To address these issues, example embodiments disclosed herein provide detecting a first touch and a second touch on a display surface of a multi-touch display device, the first touch in contact with a graphical data object and the second touch selects a data file. Using the second touch to select the data file, allows a more user-friendly direct interaction with the display surface by eliminating the ergonomic challenge of holding an arm and dragging the data file across the surface. Additionally, using the second touch, the user is not limited to one-finger gestures.

Additionally, example embodiments associate the data file with the graphical data object. This provides a navigation and selection of the data files to provide an easier user interface to enable the user to move, copy, and/or open the data file with the graphical data object to prevent any repetitive strains and alleviate discomfort to the user.

In another embodiment, the data file associated with the graphical data object may include developing a data collection. The first touch selects the graphical data object which includes the location of where to develop the data collection and the second touch selects the data file to include in the data collection. This provides a folder structure as to move and/or copy the data file by constructing the data collection. This also provides direct explicit manner to interact with the multi-touch display device by further eliminating the dragging across the surface.

In another embodiment, the data file associated with the graphical data object may include selecting the data file to launch and/or open in an application. In this embodiment, the graphical data object includes the application and the second touch selects the data file to open in the application. Using the second touch to select the data file to open in the application, reduces the number of steps for the user to open and/or execute the data file in the application. For example, the user need not open the application and then open the data file. Rather, with the second touch, the user selects the data file with the second touch to open in the application.

In a further embodiment, the first touch selects the graphical data object which may include at least one of a void space, folder, and/or application. This enables the multi-touch display device to recognize the type of graphical data object selected by the first touch. This provides the multi-touch display device to perform a type of association based on the type of the graphical data object. For example, the graphical data object may include the void space, thus the association may include developing a collection of data files. In a further example, the graphical data object may include the application, thus the association may include opening and/or executing the data file in that application.

In summary, example embodiments disclosed herein provide a more user-friendly direct interaction with a multi-touch display device by eliminating dragging data files across the display surface to prevent strains and discomfort to the user. The association of the data file and the graphical data object provide an explicit manner through which a user can select data files to copy, move, and/or open with the graphical data object.

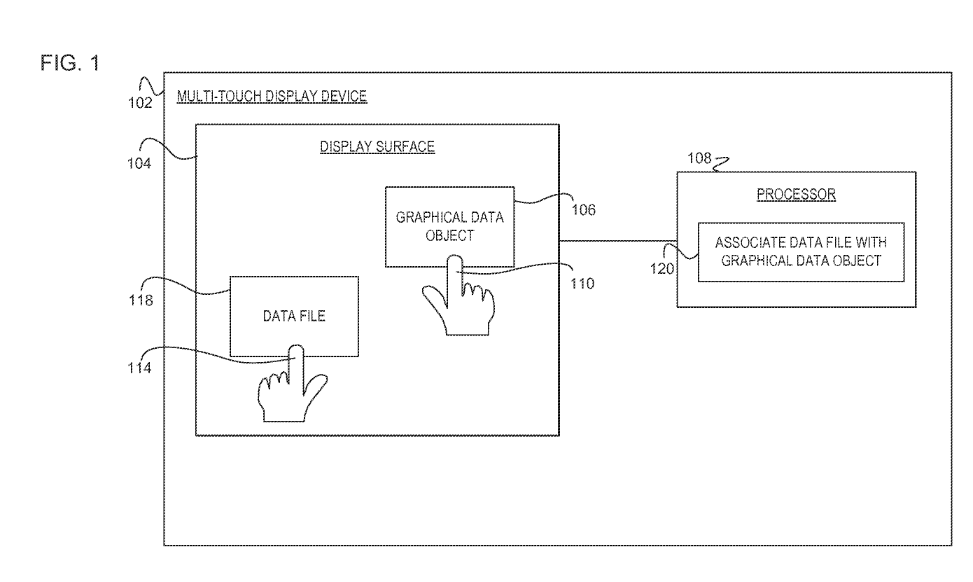

Referring now to the drawings, FIG. 1 is a block diagram of an example multi-touch display device 102 including a processor 106 and a display surface 104 with a first touch 110 and a second touch 114. Additionally, the multi-touch display device 102 detects the first touch 110 in contact with a graphical data object 106 and the second touch selects a data file 118. The processor 106 associates the data file 118 with the graphical data object 106 at module 120.

The multi-touch display device 102 is a type of computing device that enables a user to interact with the display surface 104 by making contact with the surface 104. This interaction determines the type of response that may be rendered on the display surface 104. The multi-touch display device 102 detects the touches 110 and 114 determines the location of the touches 110 and 114, and translates these touches 110 and 114 into a two-dimensional response. The multi-touch display device 102 may detect the touches 110 and 114 using various technologies. For example, the detection technology may include pressure, sensor, resistive, capacitive, acoustical, camera, and/or touch-digitizer. Embodiments of the multi-touch display device 102 include a computing device, client device, personal computer, desktop computer, laptop, a mobile device, a tablet, or other multi-touch display device 102 suitable to include the display surface 104 to recognize the first touch 110 and the second touch 114 to associate the data file 118 with the graphical data object 106 at module 120. As such, the term multi-touch display device 120 may be used interchangeably with the term computing device throughout this document.

The display surface 104 detects the first touch 110 and the second touch 114 in contact with the surface 104. The display surface 104 also renders the graphical data object 106 and the data file 118. The display surface 104 enables a user to interact with the display surface 104 through touches 110 and 114 (i.e., gestures) and render a response on the display surface 104. In this embodiment, the display surface 104 operates as a user-interface with multi-touch gestures. Embodiments of the display surface 104 include a computing screen, computing monitor, panel, plasma screen, liquid crystal display (LCD), thin film, projection, or other display technology capable of rendering the data file 118 and the graphical data object 106 and to detect the first and second touches 110 and 114, respectively.

The first touch 110 selects the graphical data object 106 on a position of the display surface 104. Specifically, the first touch 110 is in contact with the surface 204 and selects a position on the surface 204 with the graphical data object 106. In one embodiment, the first touch 110 is in continuous contact with the graphical data object 106 while the second touch 114 selects the data file 118 for association with the graphical data object 106. In another embodiment, the first touch 110 may be in contact with the graphical data object 106 for a threshold time as to enable the multi-touch display device 102 to recognize the type of graphical data object 106 the first touch 110 is selecting. This embodiment is discussed in detail in later figures. Embodiments of the first touch 110 may include utilizing a finger, hand, stylus, or appendage capable of selecting the graphical data object 106 on the display surface 104.

The graphical data object 106 is an area on the display surface 104 selected by the first touch 110. Embodiments of the graphical data object 106 include a folder, a void space, and an application. In this embodiment, the processor 108 may recognize the type of graphical data object 106 in contact with the first touch 110. This further allows the processor 108 to take the further steps to correspond to the type of graphical data object 106. For example, the graphical data object 106 may include the first touch 110 selecting a void space on the display surface 104. As such, selecting the void space indicates the processor 108 to develop the data collection at the void space so when the second touch 114 selects the data file 118 this is included in the data collection.

The second touch 114 navigates around on the display surface 104 to select the data file 104 for association to the graphical data object 106. Specifically, the second touch 114 is in contact with the surface 204 to select the data file 118. This provides a direct explicit manner to associate the data file 118 with the graphical data object 106. In one embodiment, the second touch 114 selects the data file 118 without a dragging gesture. Although FIG. 1 depicts the second touch 114 as a hand different from the first touch 110, this was done for illustration purposes and not for limiting embodiments. For example, the second touch 114 may include another finger on the same hand as the first touch 110. Embodiments of the second touch 114 include using a finger, hand, stylus, or appendage capable of selecting the data file 118 on the display surface 104

The data file 118 is a computing file which stores data which may be used by an application or by the multi-touch display device 102. As such, the data file 118 may include one more data file(s) 118. Further, the data file 118 and is selected by the second touch 114. Embodiments of the data file 118 include a folder, word processing document, media file, spreadsheet, portable document format (PDF), or combination thereof.

The processor 108 associates the data file 118 with the graphical data object 106 at module 120. Additionally, the processor 108 may communicate through a connection with the display surface 104 as indicated with line. This enables the display surface 104 to render and associate the data file 118 and the graphical data object 106. Embodiments of the processor 108 include a microchip, chipset, electronic circuit, microprocessor, semiconductor, microcontroller, central processing unit (CPU), graphics processing unit (GPU), visual processing unit (VPU), or other programmable device capable of associating the data file 118 with the graphical data object 106 at module 120.

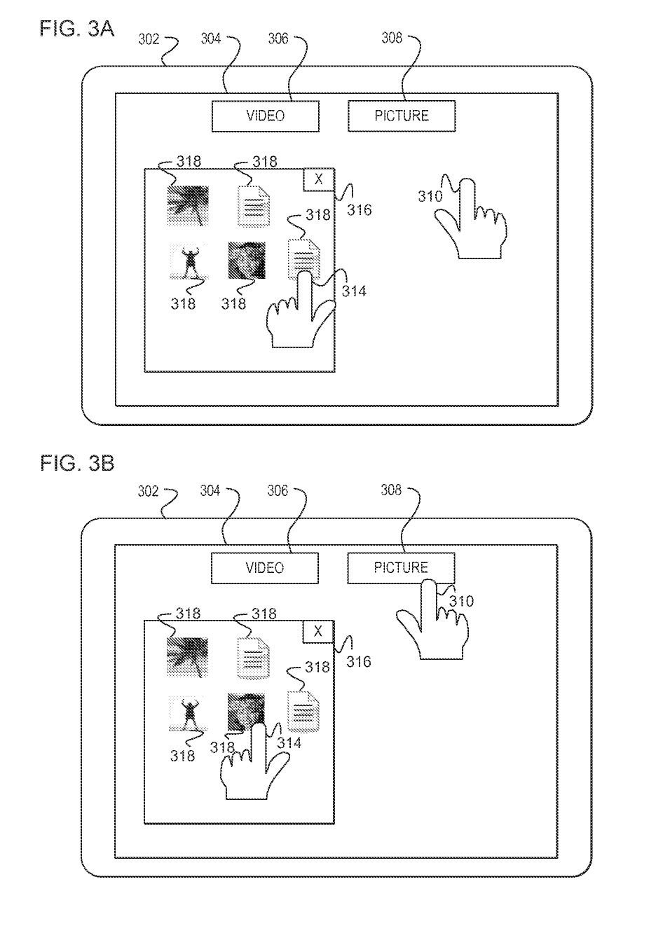

The module 120 associates the data file 118 with the graphical data object 106. In one embodiment of module 120, a data collection is developed while in another embodiment of module 120, the data file is opened and/or executed in the application. These embodiments are discussed in further detail in FIGS. 3A-3B. Embodiments of the module 120 include a set of instructions executable by the processor 108 to associate the data file 118 and the graphical data object 106.

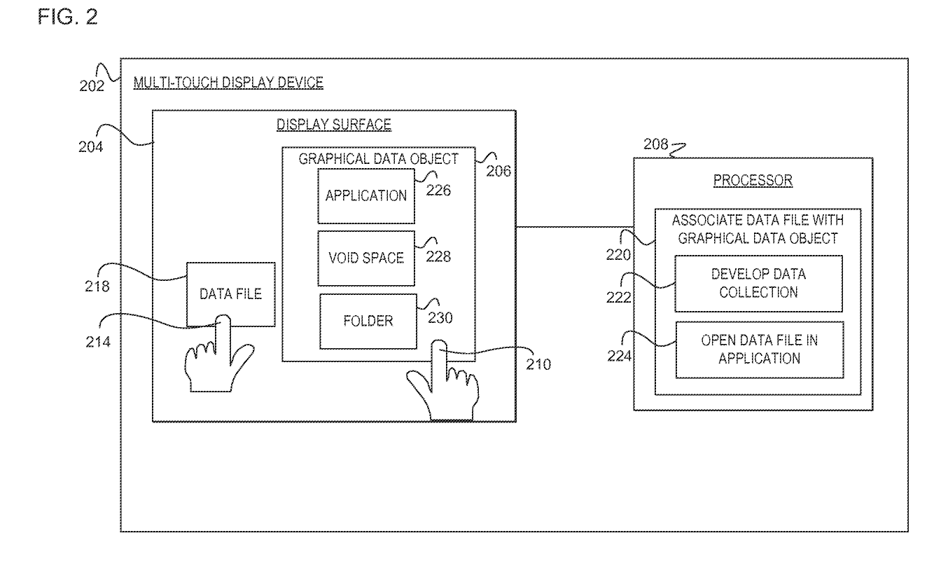

FIG. 2 is a block diagram of an example multi-touch display device 202 with a display surface 204 for a first touch 210 to select a graphical data object 206 including at least one of an application 226, a void space, and a folder 230. Additionally, the multi-touch display device 202 includes the display surface 204 for a second touch 214 to select a data file 218 and a processor 208 to associate the data file 218 with the graphical data object 206 at module 220. Module 220 includes performing at least one of developing a data collection at module 222 and opening the data file 218 in an application at module 224. The multi-touch display device 202 may be similar in structure and functionality of the multi-touch display device 102 as in FIG. 1.

The display surface 206, detects the first touch 210 and the second touch 214. The first touch 210 selects the graphical data object 206 while the second touch 214 selects the data file 218. In one embodiment, the first touch 210 is in continuous contact with the graphical data object 206 on the display surface 204 while the second touch 214 selects the data file 218 to associate with the graphical data object 206. In this embodiment, the continuous contact enables the processor 208 to associate the data file 218 with the graphical data object 206 at module 220. In another embodiment, the first touch 210 and the second touch 214 are performed without a dragging gesture. In a further embodiment, the second touch 214 navigates through a folder of one or more data file(s) 218 to select the data file 218. The display surface 204, the first touch 210, the second touch 214, and the data file 218 may be similar in functionality and structure of the display surface 104, the first touch 110, the second touch 114, and the data file 118 as in FIG. 1.

The graphical data object 206 may include at least one of the application 226, the void space 228, and the folder 230. In this embodiment, the graphical data object 206 may include types 226, 228, and 230 of the graphical data object 206. In one embodiment, the type of graphical data object 206 is identified to determine the type of association of the data file 218 with the graphical data object 206 at module 220. For example, the graphical data object 206 may include the void space 228, as such, the data file 218 may be associated with the void space 228 to build a data collection or folder at the void space 228. In this embodiment, the second touch 214 may select other data file(s) 218 to include in the data collection. The graphical data object 206 may be similar in structure and functionality of the graphical data object 106 as in FIG. 1.

The application 226 is the type of graphical data object 206 selected by the first touch 210. In this embodiment, the first touch 210 selects the application 226, as such the second touch 214 selects the data file 218 to open this data file 218 within the application 226. For example, the application 226 may include a media viewing application, thus when the second touch 214 selects the data file 218 which includes a media file, this file will open in the media viewing application. Embodiments of the application 226 include any set of instructions executable by the processor 208 to enable the multi-touch display device 202 to perform a task.

The void space 228 is the type of graphical data object 206 that includes an area on the display surface 204 without any data files and/or objects. In this embodiment, the first touch 210 selects the void space 228 indicating the desire to build the data collection of one or more data file(s) 218. Thus, when the second touch 214 selects the data file 218, this file 218 will be included in the data collection.

The folder 230 is the type of graphical data object 206 that may include one more existing data file(s) 218. In this embodiment, when the first touch 210 selects the folder 230 and the second touch 214 selects the data file 218, the data file 218 is moved and/or copied to the folder 230.

The processor 208 associates the data file 218 with the graphical data object 206 at module 208. The processor 208 may be similar in functionality and structure as the processor 108 as in FIG. 1.

The module 220 associates the data file 218 with the graphical data object 206 once the data file 218 is selected with the second touch 214. In one embodiment, the type of graphical data object 208 such as the application 226, the void space 228, and the folder 230 is identified to determine the type of association of the data file 218 with the graphical data object 206, such as to develop the data collection at module 222 and/or open the data file 218 in the application 226 at module 224. The module 220 may be similar in functionality to the module 120 as in FIG. 1.

The module 222 develops the data collection when the first touch 210 selects the void space 228 and/or folder 230. The data collection is developed at module 222 by selecting the one or more data file(s) 218 to include in the folder 230 or creating a folder representation at position on the display surface 204 as the void space 228. Specifically, module 222 is the type of association between the data file 218 and the graphical data object 206. In this embodiment, the data file 214 is associated with the graphical data object 206 by developing the data collection. Further, in this embodiment, the first touch 210 selects the void space 228 on the display surface 204, and the second touch 214 selects the data file 218 to include in the data collection. Embodiments of the module 222 include a set of instructions executable by the processor 208 to develop the data collection based on selecting the data file 218 as rendered on the display surface 204 with the second touch 214.

The module 224 associates the data file 218 with the graphical data object 206 by opening and/or executing the data file 218 in the application 226 as selected by the first touch 210. In this embodiment, the first touch 210 selects the application 226 on the display surface 204 and the second touch selects the data file 218 which is opened and/or executed in the application 226. Embodiments of the module 224 include a set of instructions executable by the processor 208 to open the data file 218 selected with the second touch 214 in an application 226 as selected by the first touch 210.

FIG. 3A is a block diagram of an example display surface 304 of a multi-touch display device 302 with a first touch 310 in contact with a void space and a second touch 314 to select a data file 318 to build a data collection at the position on the display surface 304 of the first touch 310. In another embodiment, the first touch 310 may be in contact with a data folder. In this embodiment, the data file 318 may be moved and/or copied into the data folder. The display surface 302 operates as a user-interface for the user to interact with the multi-touch display device 302 by performing the first touch 310 and the second touch 314. The multi-touch display device 302 and the display surface 304 may be similar in structure and functionality to the multi-touch display device 102 and 202 and the display surface 104 and 204 as in FIGS. 1-2, respectively.

The first touch 310 selects the type of graphical data object on the display surface 304. Specifically, FIG. 3A illustrates the first touch 310 in contact with the void space on the display surface 304. The void space as illustrated on the display surface 304 is without a label as this is the space on the display surface 304 without the data files 318 and applications 306 and 308. The first touch 310 in contact with the void space on the display surface 304 indicates the association between the data file(s) 318 and the type of the graphical data object (i.e., void space) is to move and/or copy the data file(s) 318 from the folder 316 to the position of the void space. In this embodiment, the multi-touch display device 302 may render a representation of the data collection at the position of the first touch. For example, this may include creating a folder symbol, thus when the second touch 314 selects the one or more data file(s) 318, these are included at the location of the folder symbol.

The applications 306 and 308 are types of graphical data objects. In another embodiment, the types of the graphical data objects may include the void space and/or a folder. In a further embodiment, once the first touch 310 is in contact with the graphical data object, the multi-touch display device 302 identifies the type of the graphical data object. Identifying the type of the graphical data object, enables the multi-touch display device 302 to respond with a type of the association between the data file(s) 318 and the graphical data object.

The second touch 314 selects the data files 318. Additionally, the second touch 314 may navigate through the file 316 as to select one or more data file(s) 318 to associate with the void space.

The data files 318 are selected with the second touch 314 to associate with the applications 306 and 308 and/or the void space. In FIG. 3A, the data file(s) 318 are moved and/or copied to the position of the void space, thus this builds the data collection of data file(s) 318. In this regard, the data file(s) 318 are associated with the graphical data object (i.e., void space).

The folder 316 of the data files 318 allows the second touch 314 to navigate through this folder 316 as to determine which data file(s) 318 to include within the data collection. In another embodiment, the second touch 314 navigates through the folder 316 and as such, may exit the folder 316 as indicated with the “X” at the top corner of the folder 316.

FIG. 3B is a block diagram of the display surface 304 of the multi-touch display device 302 with the first touch 310 in contact with the application 308. Additionally, the display surface 304 includes a second touch 314 to navigate through the data folder 316 to select the data file(s) 318 to open and/or execute the data file(s) 318 within the application 308. Unlike FIG. 3A, FIG. 3B illustrates the first touch 310 in contact with the picture application 308. This enables the data file 318 with the picture of a woman to be opened and/or executed in the application 308. In this embodiment, the data file 318 with the picture may be opened in the picture application 308 and/or the video application 306. In this embodiment, the data file(s) 318 selected by the second touch 314 are considered associated with the graphical data object (i.e., the application 308).

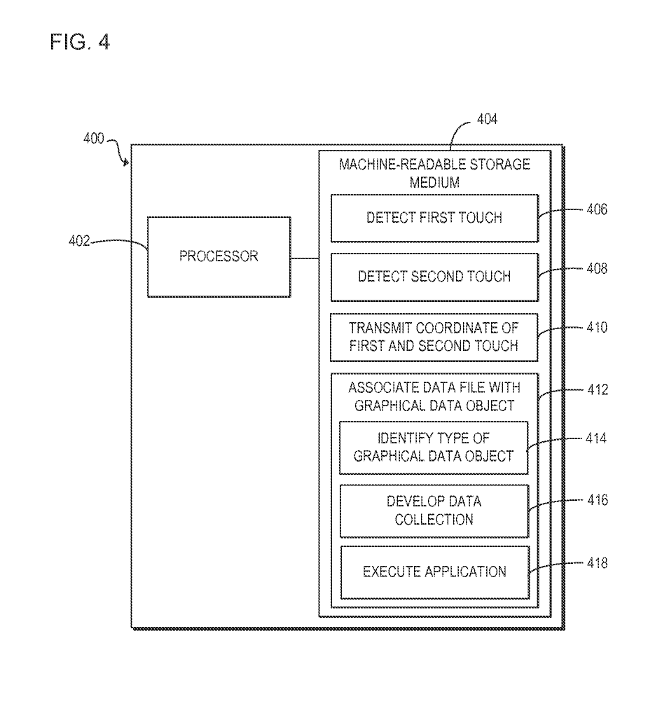

FIG. 4 is a block diagram of an example computing device 400 for detecting a first and a second touch, transmit a coordinate of each of these touches, and associate a data file with a graphical data object. Further, the computing device 400 may also identify a type of the graphical data object, develop a data collection, and execute an application. Although the computing device 400 includes processor 402 and machine-readable storage medium 404, it may also include other components that would be suitable to one skilled in the art. For example, the computing device 400 may include the display surface 304 as in FIG. 3. Additionally, the computing device 400 may be similar in structure and functionality of the multi-touch display device 102, 202, and 302 as in FIGS. 1-3, respectively.

The processor 402 may fetch, decode, and execute instructions 406, 408, 410, 412, 414, 416, and 418. The processor 402 may be similar in functionality and structure to the processor 108 and 208 as in FIG. 1 and FIG. 2, respectively. Specifically, the processor 402 executes instructions 406 and 408 to detect the first touch and second touch, instructions 410 to transmit the coordinate(s) of each of the first and second touches, and instructions 412 to associate the data file with the graphical data object. The processor 402 also executes instructions 414 to identify the type of the graphical data object, develop the data collection instructions 416, and execute the application instructions 418.

The machine-readable storage medium 404 may include instructions 406, 408, 410, 412, 414, 416, and 418 for the processor 402 to fetch, decode, and execute. The machine-readable storage medium 404 may be an electronic, magnetic, optical, memory, storage, flash-drive, or other physical device that contains or stores executable instructions. Thus, the machine-readable storage medium 404 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 404 may include an application and/or firmware which can be utilized independently and/or in conjunction with the processor 402 to fetch, decode, and/or execute instructions of the machine-readable storage medium 404. The application and/or firmware may be stored on the machine-readable storage medium 404 and/or stored on another location of the computing device 400.

Instructions 406 detect the first touch in contact with the graphical data object on the display surface of a multi-touch display device. Embodiments of instructions 406 to detect the first touch may include pressure sensing technology, sensing technology, resistive technology, capacitive technology, acoustical technology, camera oriented technology, and/or touch-digitizing technology.

Instructions 408 detect the second touch in contact with the display surface and also select the data file to associate with the graphical data object selected at instructions 406. Embodiments of instructions 408 to detect the second touch may include pressure sensing technology, sensing technology, resistive technology, capacitive technology, acoustical technology, camera oriented technology, and/or touch-digitizing technology.

Instructions 410 transmit one or more coordinate(s) of a position of the first touch and the second touch on the display surface. In this embodiment, the computing device may track what is rendered on the display surface to determine which specific data files to associate with which graphical data objects as selected by the first touch and the second touch at instructions 406 and 408, respectively.

Instructions 412 associate the data file selected by the second touch at instructions 408 with the graphical data object selected by the first touch at instructions 406. In one embodiment the association is dependent on the type of graphical data object as selected by the first touch at instructions 406.

Instructions 414 identify the type of graphical data object selected by the first touch at instructions 406. In one embodiment of instructions 414, the type of graphical data object may include at least one of a void space, folder, and application. Identifying the type of graphical data object, the computing device 400 determines the type of association between the graphical data object selected at instructions 406 and the data file selected by instructions 408.

Instructions 416 develops the data collection as the type of association between the data file and graphical data object. In this embodiment, the graphical data object in contact with the first touch at instructions 406 includes the void space and/or folder.

Instructions 418 execute and/or open the data file in the application as the type of association between the data file and the graphical data object. In this embodiment, the graphical data object in contact with the first touch at instructions 406 includes the application.

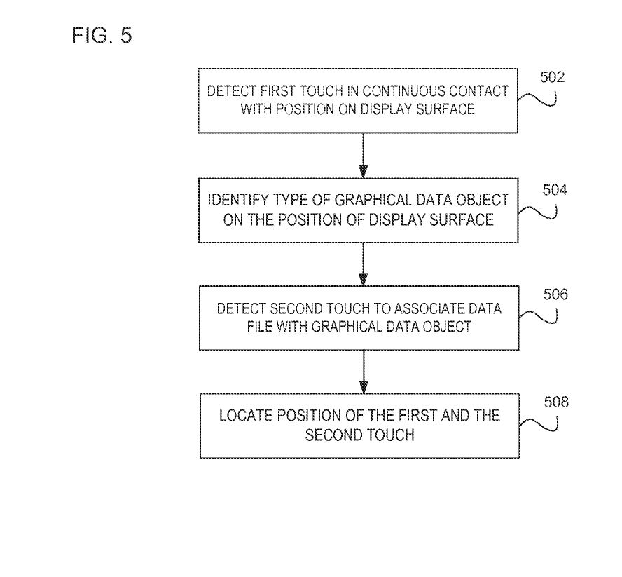

FIG. 5 is a flowchart of an example method performed on a computing device to detect a first touch and a second touch, associate a data file with a graphical data object, and locate the positions of the touches. Although FIG. 5 is described as being performed on computing device 400 as in FIG. 4, it may also be executed on multi-touch device 102, 202, and 302 as in FIGS. 1-3. Additionally, the method may also be executed on other suitable components as will be apparent to those skilled in the art. For example, FIG. 5 may be implemented in the form of executable instructions on a machine-readable storage medium, such as machine-readable storage medium 404 in FIG. 4.

At operation 502 the computing device detects the first touch in continuous contact with a graphical data object on the display surface. Using the first touch in continuous contact with the graphical data object, enables the computing device to distinguish the first touch from the second touch. For example, the first touch in continuous contact with the display surface is a different type of touch from the second touch which may include a tap to select to the data file.

At operation 504 the computing device identifies the type of graphical data object. Identifying the type of graphical data object, the computing device may perform a type of association between the graphical data object and the data file. The type of association may include developing a data collection and/or executing the data file in the application. In one embodiment, operation 504 identifies the type of graphical data object after a period of time the first touch has been detected selecting the graphical data object at operation 502.

At operation 506 the computing device detects a second touch on the display surface. The second touch selects a data file to associate with the graphical data object identified at operation 504.

At operation 508 the computing device locates a respective position on the display surface of the first touch and a position of the second touch with coordinates. In this embodiment, the computing device detects the first touch and the second touch at operation 502 and operation 506. Once detecting the touches, the computing device may use coordinates to identify the position on the display surface of each of the touches. This enables the computing device to determine what is rendered on the display surface, such as the data files and graphical data objects. Determining what is rendered on the display surface, the computing device can track which data files to associate with which graphical data objects. In one embodiment operation 508 locates the position of the touches once receiving the touches at operations 502 and 506 but prior to associating the data file with the graphical data object. In another embodiment, operation 508 displays the association between the data file and the graphical data object. In this embodiment, the position of the touches are determined using coordinates to determine where to render the location of the association on the display surface.

In summary, example embodiments disclosed herein provide a more user-friendly direct interaction with a multi-touch display device by eliminating dragging data files across the display surface to prevent strains and discomfort to the user. The association of the data file and the graphical data object provide an explicit manner through which a user can select data files to copy, move, and/or open with the graphical data object.

We claim:

1. A non-transitory machine-readable storage medium encoded with instructions executable by a processor of a computing device, the storage medium comprising instructions to:
detect a first touch on a display surface of a multi-touch display device, the first touch is in continuous contact with a first location of the display surface corresponding to a graphical data object on the display surface;
detect a second touch at a second location of the display surface corresponding a data file while the first touch is in contact with the display surface, the second touch selects the data file; and
associate the data file with the graphical data object.

2. The non-transitory machine-readable storage medium encoded with the instructions of claim 1, wherein to associate the data file with the graphical data object includes is further comprising instructions to:
develop a data collection, the graphical data object includes a location on the display surface of where to develop the data collection, the second touch selects the data file to include in the data collection.

3. The non-transitory machine-readable storage medium encoded with the instructions of claim 1, wherein to associate the data file with the graphical data object includes is further comprising instructions to:
execute an application, the graphical data object includes the application and the second touch selects the data file to open in the application.

4. The non-transitory machine-readable storage medium including the instructions of claim 1, further comprising instructions to:
transmit a coordinate of the first and the second touch to the processor to determine a position of the first touch and the second touch on the display surface.

5. The non-transitory machine-readable storage medium including the instructions of claim 1, wherein the first and the second touch are without a drag gesture.

6. The non-transitory machine-readable storage medium including the instructions of claim 1, wherein the graphical data object on the display surface of the computing device includes one of: a folder, a void space, and an application.

7. The non-transitory machine-readable storage medium including the instructions of claim 1, wherein the association of the data file with the graphical data object depends on a type of the graphical data object.

8. A multi-touch display device comprising:
a display component to render a user interface to include a graphical data object and a data file;
a sensor to:
detect a first touch in contact with a first location of the display surface corresponding to the graphical data object on the display surface; and
detect a second touch at a second location of the display object corresponding to the data file while the first touch is in contact with the display surface; and
a processor to associate the data file with the graphical data object.

9. The multi-touch display device of claim 8 wherein:
to associate the data file with the graphical data object, the processor is to develop a data collection when the first touch selects a void space in a position of where to develop the data collection on the display surface and the second touch selects the data file to include in the data collection.

10. The multi-touch display device of claim 8 wherein:
to associate the data file with the graphical data object, the processor is to execute an application when the first touch selects the application on the display surface and the second touch selects the data file to open in the application.

11. The multi-touch display device of claim 8 wherein the second touch navigates through a folder to select the data file.

12. The multi-touch display device of claim 8 wherein the first and the second touch are without a drag and drop gesture.

13. A method executed by a computing device, the method comprising:
detecting a first touch on a surface of the computing device, the first touch in continuous contact with a graphical data object on the display surface;
identifying a type of the graphical data object with the first touch in contact with the display surface; and
detecting a second touch on the display surface of the computing device while the first touch is in contact with the display surface, the second touch selects a data file to associate the data file with the graphical data object, wherein the association is dependent on the type of graphical data object.

14. The method of claim 13 wherein to associate the data file with the graphical data object includes at least one of:
developing a data collection, the second touch selects the data file to include in the data collection; and
executing an application, the second touch selects the data file to open and the graphical data object includes the application.

15. The method of claim 13 wherein to associate the data file with the graphical data object depends on a type of the graphical data object and the method is further comprising:
locating a respective position on the display surface of each the first touch and the second touch with coordinates.
